(19) United States
(12) Patent Application Publication
(10) Pub. No.: US 2018/0146623 A1
(43) Pub. Date: May 31, 2018

(54) Chopping Blade of a Chopping Drum of a Forage Harvester

(71) Applicant: CLAAS Saulgau GmbH, Bad Saulgau (DE)

(72) Inventors: Stefan Birkhofer, Stockach (DE); Peter Kajtar, Bad Saulgau (DE)

(21) Appl. No.: 15/820,513

(22) Filed: Nov. 22, 2017

(30) Foreign Application Priority Data
Nov. 30, 2016 (DE) 102016123174.6

(51) Int. Cl. A01F 29/09; A01F 29/06

(52) U.S. Cl. CPC A01F 29/09; A01D 43/08; A01F 29/06; A01F 29/095

(57) ABSTRACT

Chopping blade (10) of a chopping drum of a forage harvester, having a base body (11) which comprises a fastening portion (12) for fastening the chopping blade (10) to the chopping drum and a cutting portion (13) for the harvested crop to be chopped, wherein at least one crop guiding element (15) for guiding the harvested crop is fastened to the inner surface of the fastening portion (12).

The invention relates to a chopping blade of a chopping drum of a forage harvester.

A chopping drum of a forage harvester comprising chopping blades is disclosed in DE 199 18 553 A1. The chopping blades are fastened via blade holders to the chopping drum, wherein the blade holders are distributed over the drum outer surface of the chopping drum. The blade holders of the chopping blades form on one side a throw shovel surface which is curved in a concave manner, which is advantageous both for projecting chopped particles and also for pneumatic conveying. This throw shovel surface accordingly serves as a guide surface for the chopped harvested crop and accordingly as a crop guiding element. In the chopping drum disclosed in DE 199 18 553 Al, accordingly the function of the fastening of the chopping blades to the chopping drum and the crop guiding function for guiding chopped harvested crop is provided together by the blade holder, so that accordingly there is a functional integration here of the fastening function and the crop guiding function in the blade holders.

Proceeding therefrom, the object of the present invention is to provide a novel chopping blade of a chopping drum of a forage harvester.

This object is achieved by a chopping blade of a chopping drum of a forage harvester according to claim 1.

According to the invention, at least one crop guiding element for guiding the harvested crop is fastened to the fastening portion of the chopping blade.

In the chopping blade according to the invention the fastening function for the chopping blade on the chopping drum and the crop guiding function for guiding the harvested crop is not undertaken by one and the same component but these functions are allocated instead to different sub-assemblies of the chopping blade.

Thus the chopping blade according to the invention has the base body which provides the fastening function for the chopping blade on the chopping drum and which serves for cutting the harvested crop. Moreover, the chopping blade comprises at least one crop guiding element fastened to the fastening portion for providing the guiding function for the harvested crop. This has the advantage that the individual sub-assemblies of the chopping blade may be optimally designed for the respective function thereof. Thus, for example, optimally adapted materials may be selected for these sub-assemblies of the chopping blade. Moreover, it is possible to replace crop guiding elements or even to reuse the crop guiding elements in the case of wear of the base body. Moreover, the chopping blade according to the invention may be produced in a simple manner.

According to one development, the respective crop guiding element is a hollow body. Thus the chopping blade may be designed with a low weight.

According to one development, the respective crop guiding element is connected to the base body by a riveted connection or a screw connection or an adhesively-bonded connection or an injection-molded connection or a die-cast connection. This permits a simple production of the chopping blade according to the invention.

Preferred developments of the invention are disclosed from the subclaims and the following description. Exemplary embodiments of the invention are described in more detail with reference to the drawings, without being limited thereby. In the drawings:

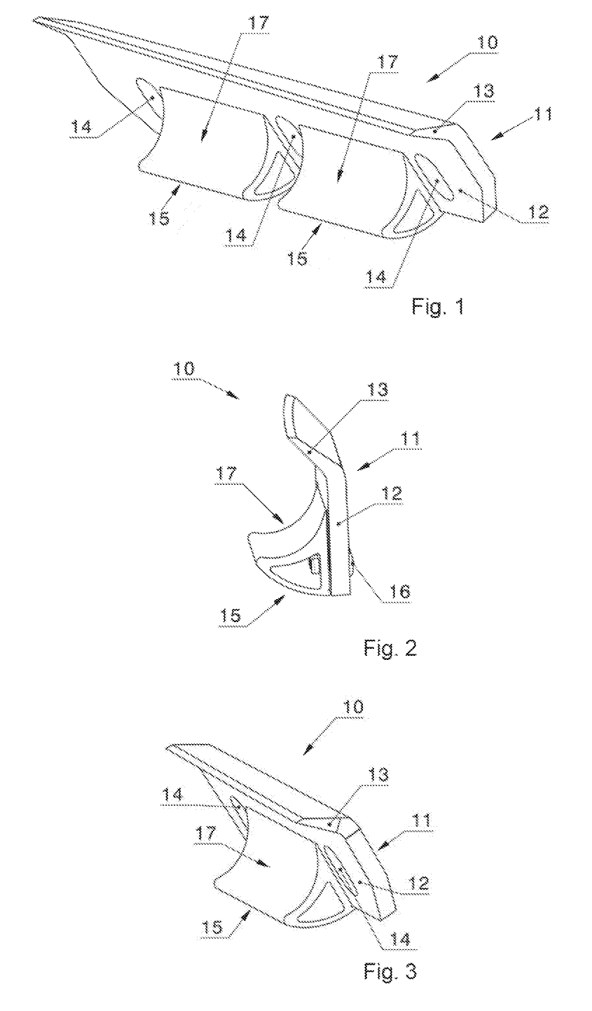

FIG. 1 shows a perspective view of a first exemplary embodiment of a chopping blade according to the invention;

FIG. 2 shows a side view of the chopping blade of FIG. 1;

FIG. 3 shows a perspective view of a second exemplary embodiment of a chopping blade according to the invention;

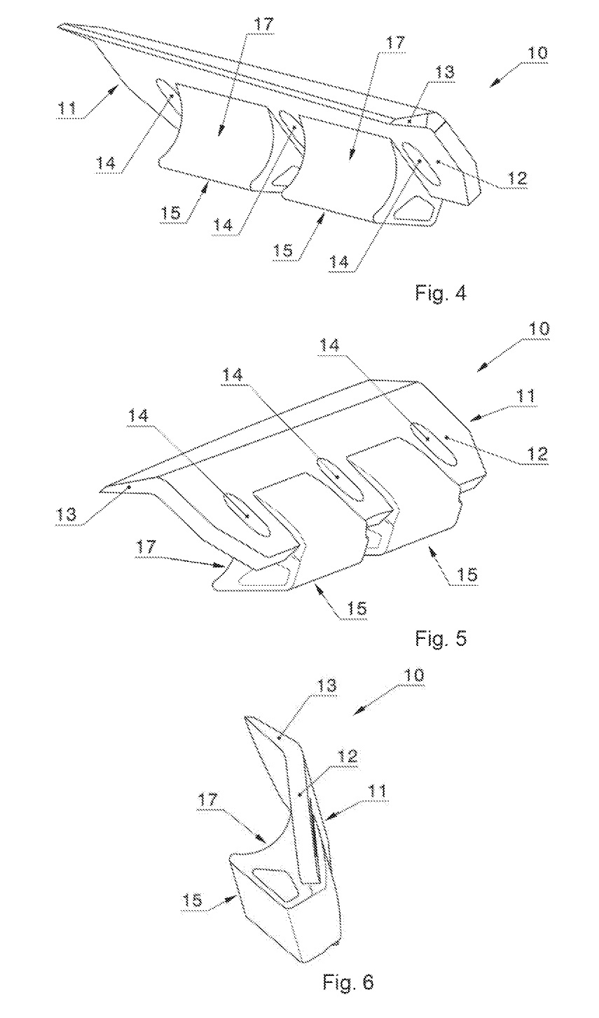

FIG. 4 shows a perspective view of a third exemplary embodiment of a chopping blade according to the invention;

FIG. 5 shows a further perspective view of the chopping blade of FIG. 4, and

FIG. 6 shows a side view of the chopping blade of FIGS. 4 and 5.

The invention relates to a chopping blade of a chopping drum of a forage harvester.

FIGS. 1 and 2 show different views of a first exemplary embodiment of a chopping blade 10 according to the invention. The chopping blade 10 according to the invention has a base body 11 with a fastening portion for fastening the chopping blade 10 to a chopping drum, not shown, and with a cutting portion 13 for cutting the harvested crop to be chopped. According to the preferred exemplary embodiment shown, the cutting portion 13 of the base body 11 is angled back relative to the fastening portion 12 thereof.

In the exemplary embodiment of FIGS. 1 and 2 three fastening elements 14 which are configured as slots are formed on the fastening portion 12, the chopping blade 10, namely the base body 11 thereof, ultimately being able to be fastened thereby to the chopping drum, namely via fastening screws which extend into the chopping drum through the fastening elements 14 which are configured as slots.

In addition to the base body 11 the chopping blade 10 has at least one crop guiding element 15. In each case one crop guiding element 15 is arranged between two respective fastening elements 14 spaced apart from one another, so that accordingly in the exemplary embodiment of FIGS. 1 and 2 two crop guiding elements are present, said crop guiding elements being fastened to the fastening portion 12 of the base body 11, namely in the exemplary embodiment of FIGS. 1 and 2, via fastening means 16 configured as rivets.

The respective crop guiding element 15, on a guide surface 17 facing the cutting portion 13 of the base body 11, has a contour which is curved in a concave manner and accordingly inwardly, which serves for the guidance of the harvested crop, namely of the chopped harvested crop.

In the chopping blade 10 according to the invention, accordingly the fastening function for the chopping blade 10 on the chopping drum and the cutting function for the harvested crop are provided by the base body 11. The guiding function for the harvested crop is provided by at least one crop guiding element 17 which is designed as a separate sub-assembly and is connected to the base body 11, namely in FIGS. 1 and 2 via a riveted connection by the rivets 16.

Accordingly, within the meaning of the present invention the fastening function and the cutting function may be separated from the guiding function and allocated to sub-assemblies of the chopping blade 10 which are connected together, namely the fastening function and the cutting function to the base body 11 of the chopping blade 10 and the guiding function for the harvested crop to the or each crop guiding element of the chopping blade 10. As a result, the individual sub-assemblies of the chopping blade 10 may be optimally designed for their respective function, in particular by the choice of a suitable material.

Thus the base body 11 is preferably manufactured from a metal material, preferably from a steel material.

The or each crop guiding element 15 may also be manufactured from a metal material, thus for example from an aluminum material, zinc material or even magnesium material. Alternatively, the or each crop guiding element 15 may also be manufactured from a plastics material.

In the exemplary embodiment of FIGS. 1 and 2, the respective crop guiding element 15 is designed as a hollow body. This is preferred in order to provide a chopping blade 10 with a low weight.

It is also possible to design the crop guiding element 15 as a solid body.

In the exemplary embodiment of FIGS. 1 and 2 the respective crop guiding element 15 is connected to the base body 11 of the chopping blade 10 via a riveted connection. Alternatively, a screw connection or an adhesively-bonded connection or a die-cast connection may also be used.

FIG. 3 shows a second exemplary embodiment of a chopping blade 10 according to the invention which merely differs from the exemplary embodiment of FIGS. 1 and 2 in that said chopping blade has in the region of the fastening portion 12 of the base body 11 only two fastening elements 14 which are configured as slots and in that a single crop guiding element 15 is positioned and mounted on the fastening portion 12 of the base body 11 between these two fastening elements 14. With regard to all of the remaining details, the exemplary embodiment of FIG. 3 coincides with the exemplary embodiment of FIGS. 1 and 2.

A third exemplary embodiment of a chopping blade 10 according to the invention is shown in FIGS. 4 to 6. In the chopping blade 10 of FIGS. 4 to 6, the crop guiding elements 15 are crop guiding elements made of a plastics material which are preferably connected via an injection-molding method to the fastening portion 12 of the base body 11 of the chopping blade 10.

Thus it may be derived, in particular, from FIGS. 5 and that the fastening portion 12 is enclosed in the region of each crop guiding element 15 on both sides by the respective crop guiding element 15, wherein this connection may be provided by an adhesively-bonded connection as an alternative to an injection-molded connection.

The crop guiding elements 15 of the exemplary embodiment of FIGS. 4 to 6 are also designed as hollow bodies.

A chopping blade 10 according to the invention accordingly consists of the base body 11 which provides the fastening portion 12 and the cutting portion 13, wherein this base body 11 is preferably manufactured from a hardened steel material. The fastening portion 12 serves for fastening to the chopping drum. At least one crop guiding element 15 is fastened to the fastening portion 12 of the base body 11, said crop guiding element preferably being manufactured from a different material from the base body 11, in particular from a more lightweight material such as aluminum material or even a plastics material. The or each crop guiding element 15 exclusively undertakes the function of the crop guidance of the harvested crop and does not serve for fastening the chopping blade 10 to the chopping drum.

Preferably, the crop guiding elements 15 are designed as hollow bodies but alternatively they may also be designed as solid bodies.

The connection of the or each crop guiding element 15 to the fastening portion 12 of the base body 11 may be carried out by injection-molding, by adhesive bonding, via a riveted connection or even via a screw connection. For the injection-molding, depending on the material of the respective crop guiding element 15, either a plastics composite injection-molding or an aluminum die casting may be used in order to injection-mold the respective crop guiding element 15 partially around the fastening portion 12 of the base body 11 in the region of the respective crop guiding element 15.

The invention provides numerous advantages. By separating the function of crop guidance from the cutting function and the fastening function, the individual sub-assemblies which undertake the respective functions are optimally designed for the respective function. The base body 11 may be produced in a simple and cost-effective manner, and the same applies to the respective crop guiding element 15 which may be produced from a more flexible and more lightweight material. By replacing the crop guiding elements 15, the guiding function may be altered for the harvested crop, in particular by using crop guiding elements 15 with different contours in the region of the guide surface 17 facing the cutting portion 13. In the case of wear of the base body 11, the crop guiding elements 15 may be reused. Accordingly, potentially greater wear may be present on the more flexible material of the respective crop guiding element 15. The shape alters over the service life of the chopping blade 10 due to wear. Thus even when the cutting portion 13 is worn and the crop guiding element 15 is worn down, sufficient space is provided for the harvested crop, namely for the guidance thereof.

### LIST OF REFERENCE NUMERALS

10 Chopping blade

11 Base body

12 Fastening portion

13 Cutting portion

14 Fastening element

15 Crop guiding element

16 Fastening means

17 Guide surface

1. A chopping blade (10) of a chopping drum of a forage harvester, having a base body (11) which comprises a fastening portion (12) for fastening the chopping blade (10) to the chopping drum and a cutting portion (13) for the harvested crop to be chopped, characterized in that at least one crop guiding element (15), which is provided exclusively for guiding the harvested crop, is fastened to the inner surface of the fastening portion (12).

2. The chopping blade according to claim 1, characterized in that the fastening portion (12) comprises at least two fastening elements (14) spaced apart from one another, wherein one respective crop guiding element (15) is positioned in each case between two adjacent fastening elements (14).

3. The chopping blade according to claim 1, characterized in that the respective crop guiding element (15) is contoured in a concave manner on a guide surface (17) facing the cutting portion (13).

4. The chopping blade according to claim 1, characterized in that the respective crop guiding element (15) is a hollow body.

5. The chopping blade according to claim 1, characterized in that the respective crop guiding element (15) and the base body (11) are produced from different materials.

6. The chopping blade according to claim 5, characterized in that the base body (11) is manufactured from a steel material.

7. The chopping blade according to claim 5, characterized in that the respective crop guiding element (11) is manufactured from an aluminum material or a plastics material.

8. The chopping blade according to claim 1, characterized in that the respective crop guiding element (15) is connected to the base body (11) by a riveted connection or a screw connection.

9. The chopping blade according to claim 1, characterized in that the respective crop guiding element (15) is connected to the base body (11) by an adhesively-bonded connection or an injection-molded connection or a die-cast connection.

10. The chopping blade according to claim 1, characterized in that the cutting portion (13) is angled back relative to the fastening portion (12).
